(19) United States
(12) Patent Application Publication
(10) Pub. No.: US 2020/0173798 A1
(43) Pub. Date: Jun. 4, 2020

(54) GENERATION APPARATUS, CONTROL METHOD OF GENERATION APPARATUS, AND NON-TRANSITORY COMPUTER-READABLE STORAGE MEDIUM

(71) Applicant: HONDA MOTOR CO., LTD., Tokyo (JP)

(72) Inventors: Mafuyu Koseki, Tokyo (JP); Hidekazu Shintani, Wako-shi (JP); Naohide Aizawa, Tokyo (JP); Takaaki Ishikawa, Wako-shi (JP)

(73) Assignee: HONDA MOTOR CO., LTD., Tokyo (JP)

(21) Appl. No.: 16/688,068

(22) Filed: Nov. 19, 2019

(30) Foreign Application Priority Data
Nov. 29, 2018 (JP) 2018-223956

(51) Int. Cl. G01C 21/34; G05D 1/02; G08G 1/01; G06K 9/00; B60W 40/09; G01W 1/10

(52) U.S. Cl. CPC G01C 21/3461; G01C 21/3484; G01C 21/343; G05D 1/0214; G05D 2201/0213; G06K 9/00677; B60W 40/09; G01W 1/10; G06K 9/00791; G08G 1/0125

(57) ABSTRACT

A generation apparatus for generating a moving plan including information of a feature point on a route., comprises an extraction unit configured to extract the information of the feature point on the route; and a generation unit configured to generate the moving plan based on the information of the feature point and profile information of a user.

CROSS-REFERENCE TO RELATED APPLICATION(S)

This application claims priority to and the benefit of Japanese Patent Application No. 2018-223956 filed on Nov. 29, 2018, the entire disclosure of which is incorporated herein by reference.

### BACKGROUND OF THE INVENTION

### Field of the Invention

The present invention relates to a generation apparatus, a control method of the generation apparatus, and a non-transitory computer-readable storage medium.

### Description of the Related Art

Conventionally, in a case in which a destination is a place to visit for the first time or a remote site, route setting for navigation is often performed before departure using a portable information terminal such as smartphone or an in-vehicle navigation device. In some cases, it is difficult to confirm a route because a navigation device is not mounted or the user is traveling by a two-wheeled vehicle. In such a case, the user departs after checking the route in advance. In addition, if the user wants to know points of interest (restaurant, recommended spot, event, and the like) on a route, he/she checks them in advance and then departs, or checks while traveling.

However, in actual traveling of a vehicle, a point requiring attention can exist, where the guide of the navigation device is hard to understand, or a complicatedly branching road makes the driver confused about the direction to advance or take a wrong road. In addition, a search to check the points of interest may take time, and it may be impossible to appropriately obtain desired information.

International Publication No. 2016/178282 describes estimating the moving destination of a user, acquiring area information of the estimated moving destination (for example, information of an event in a station of the moving destination), and displaying the information to the user.

However, the technique described in International Publication No. 2016/178282 cannot provide adaptive information for each user. Hence, when a user travels on a set route, it is difficult to provide information concerning a feature point (for example, a point requiring attention, a point of interest, or the like) important for the user.

The present invention has been made in consideration of the above-described problem, and provides, for each user, information concerning a feature point on a route important for the user.

### SUMMARY OF THE INVENTION

According to one aspect of the present invention, there is provided a generation apparatus for generating a moving plan including information of a feature point on a route, comprising: an extraction unit configured to extract the information of the feature point on the route; and a generation unit configured to generate the moving plan based on the information of the feature point and profile illumination of a user.

### BRIEF DESCRIPTION OF THE DRAWINGS

FIG. 1 is a view for explaining an example of the arrangement of a generation system according to an embodiment of the present invention;

FIGS. 2A to 2C are block diagrams for explaining examples of the arrangements of apparatuses included in the generation system according to an embodiment of the present invention;

FIG. 3 is a flowchart showing an example of the procedure of overall processing executed by a generation apparatus according to an embodiment of the present invention;

FIG. 4 is a flowchart showing an example of the procedure of processing of extracting a first caution point where a user readily takes a wrong road, which is executed by the generation apparatus according to an embodiment of the present invention;

FIG. 5 is a flowchart showing an example of the procedure of processing of extracting a second caution point where an abrupt stop readily occurs, which is executed by the generation apparatus according to an embodiment of the present invention;

FIG. 6 is a flowchart showing an example of the procedure of processing of extracting a first point of interest in which the user is assumed to be interested, which is executed by the generation apparatus according to an embodiment of the present invention;

FIG. 7 is a flowchart showing an example of the procedure of processing of extracting a second point of interest in which other users are interested, which is executed by the generation apparatus according to an embodiment of the present invention;

FIG. 8 is a flowchart showing an example of the procedure of moving plan generation processing executed by the generation apparatus according to an embodiment of the present invention; and

FIGS. 9A and 9B are flowcharts showing an example of the procedure of video ratio adjustment processing executed by the generation apparatus according to an embodiment of the present invention.

### DESCRIPTION OF THE EMBODIMENTS

An embodiment of the present invention will now be described with reference to the accompanying drawings. Note that the drawings are merely schematic views for explaining the embodiment, and, for example, the dimensions of elements shown in the drawings do not necessarily reflect the actuality. In addition, the same reference numerals denote similar elements throughout the drawings, and a description of repetitive contents in this specification will be omitted.

<Arrangement>

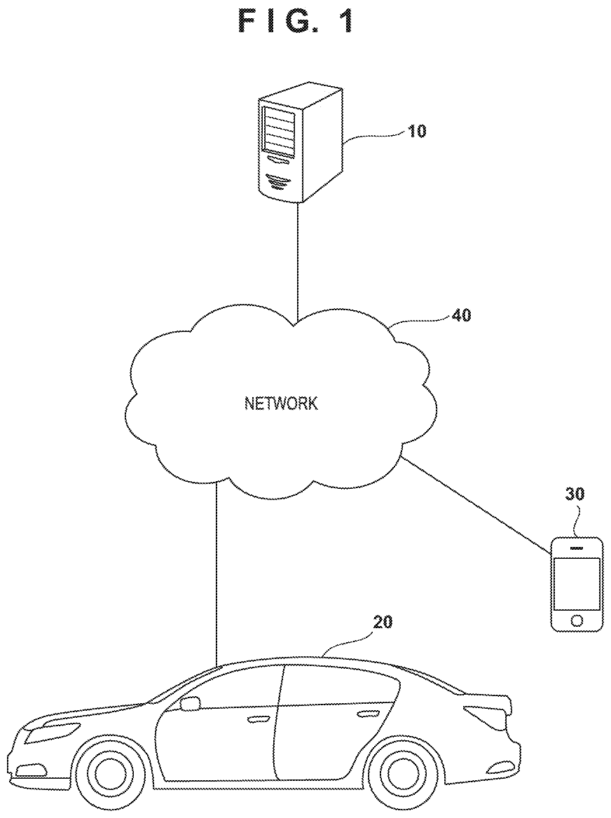

FIG. 1 is a view for explaining an example of the arrangement of a generation system according to an embodiment of the present invention. The generation system includes a generation apparatus 10, one or more vehicles 20, and one or more communication apparatuses 30, and is configured such that the generation apparatus 10, the one or more vehicles 20, and the one or more communication apparatuses 30 can communicate via a network 40.

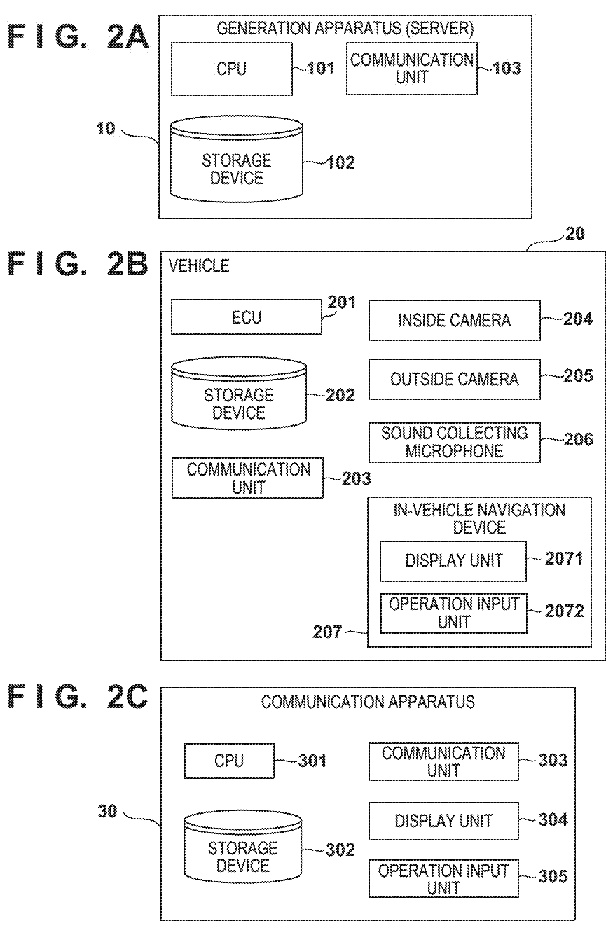

FIGS. 2A to 2C are block diagrams showing examples of the arrangements of the generation apparatus 10, the vehicle 20, and the communication apparatus 30. The generation apparatus 10 functions as a server apparatus, generates a moving plan (for example, an image or a video including a feature point on a route) including a feature point on a route from a departure place to a destination, and outputs it to the vehicle 20 or the communication apparatus 30. The moving plan is, for example, a video in which a plurality of videos in traveling, which are observed from the vehicle 20 in actual traveling on a feature point, are connected and displayed for each feature point. For example, if a feature point is an intersection, and a left turn is required at the intersection when complying with a set route, an arrow or a line along the route may be Superimposed on the video. A series of videos from a point slightly before a point to enter the intersection until the vehicle makes a left turn at the intersection and leaves the intersection after the left turn is a series of videos of the feature point. Such videos are connected and continuously displayed for a plurality of feature points, thereby generating a moving plan. Note that the moving plan need not always be a video. A plurality of still images of each feature point may be connected, and the still image may sequentially selectively be displayed for a predetermined time. In addition, videos and still images may be combined such that, for example, caution points are displayed by videos, and points of interest are displayed by still images.

The generation apparatus 10 includes a CPU 101, a storage device 102, and a communication unit 103. The CPU 101 reads out a program stored in the storage device 102 and executes it, thereby executing processing according to the embodiment. The storage device 102 stores various kinds of information.

The storage device 102 stores the program to be read out and executed by the CPU 101, and also stores information acquired from the one or more vehicles 20 or communication apparatuses 30 via the communication unit 103, and information acquired from the network 40 via the communication unit 103. The storage device 102 stores, for example, navigation information received by the generation apparatus 10 from the vehicle 20 or the communication apparatus 30, which is input by the user via the vehicle 20 or the communication apparatus 30. The navigation information includes user ID information, the information of a departure place and a destination (or a waypoint), the information of a scheduled traveling date/time, and the like.

The storage device 102 also receives and stores traveling information of a plurality of vehicles 20. The traveling information is information used to extract a feature point (caution point or point of interest). The traveling information includes position information of the vehicle 20, speed information, acceleration information, position information of an ignition-off point, information of the stepping amount of a brake pedal, actuation information of an anti-lock brake system (ABS), actuation information of an automatic brake, actuation information of an adaptive cruise control, actuation information of a horn, and the like. In addition, the traveling information includes occurrence information of reroute for a route, occurrence information of a U-turn for a route, and operation information concerning a scale change operation of a map displayed on the route guide screen of an in-vehicle navigation device 207 to be described later. The traveling information also includes image capturing information of an outside camera (outside camera 205 to be described later) installed on the vehicle 20, image capturing information of an inside camera (inside camera 204 to be described later) installed in the vehicle 20, sound collection information of a sound collecting microphone (sound collecting microphone 206 to be described later) installed in the vehicle 20, heart rate information measured by a heart rate measuring device (not shown) attached to the driver of the vehicle 20, and the like.

Additionally, the storage device 102 stores received profile information of the user. The profile information is information used to adjust a video ratio concerning a feature point (caution point or point of interest) such that it becomes a ratio suitable for the user when generating a moving plan. The profile information of the user includes the number of times of traveling in the past by the user for each link of a route, type information (for example, four-wheeled vehicle or two-wheeled vehicle) of a vehicle scheduled to be used by the user when moving on a route, information concerning a passenger of the user, and information of the scheduled traveling date/time of a route. In addition, the profile information of the user includes information of the destination of a route, information of a scheduled traveling distance and scheduled traveling time of a route, driving skill information of the user (for example, information representing whether the user has a high driving skill), and weather information (heavy rain, snow, dense fog, etc.) at the scheduled traveling date/time of a route. In addition, the profile information of the user includes natural disaster information of a route (for example, an advisory or warning, landslide information upon heavy rain, river flooding information, volcanic eruption information, and road surface freeze information), and the like. In addition, the traveling information includes history information of past utterance contents acquired by the sound collecting microphone (for example, the sound collecting microphone 206 to be described later) provided in the vehicle.

The communication unit 103 transmits/receives various kinds of information by wired or wireless communication. The network 40 is, for example, the Internet and/or a local area network (LAN).

The vehicle 20 is, for example, a four-wheeled vehicle, but may be another vehicle such as a two-wheeled vehicle. The vehicle 20 includes an ECU (Electronic Control Unit) 201, a storage device 202, a communication unit 203, the inside camera 204, the outside camera 205, the sound collecting microphone 206, and the in-vehicle navigation device 207.

The ECU 201 includes a CPU a memory, and a communication interface. The CPU performs predetermined processing based on information (data or an electrical signal) received via the communication interface, stores the processing result in the memory, or outputs it to another element via the communication interface. The ECU 201 controls a driving mechanism based on the operation amount of an acceleration operator (accelerator pedal) by the driver. In addition, the ECU 201 controls a braking mechanism based on the operation amount of a braking operator (brake pedal) by the driver. The braking mechanism is, for example, a disc brake provided on each wheel of the vehicle 20. Additionally, the ECU 201 controls a steering mechanism based on the operation amount of a steering operator (steering wheel) by the driver. The steeling mechanism includes a power steering. The ECU 201 can acquire the operation amounts of the operators and analyze the driving skill of the driver based on the history of the acquired operation amounts.

Additionally, based on images captured by the inside camera 204 and the outside camera 205 or voice information collected by the sound collecting microphone 206, the ECU 201 performs predetermined analysis concerning the internal environment (for example, the behavior of the driver) of the vehicle 20 and the peripheral environment (for example, the color of a traffic signal and whether another vehicle exists on the periphery) outside the vehicle or concerning the utterance contents of an occupant.

The storage device 202 stores analysis results of various kinds of information by the ECU 201, images captured by the inside camera 204 and the outside camera 205, voice information collected by the sound collecting microphone 206, navigation information acquired from the in-vehicle navigation device 207, and the like.

The communication unit 2.03 can communicate with the generation apparatus 10 via the network 40 and transmit/receive various kinds of information by wired or wireless communication. The communication unit 203 transmits various kinds of information stored in the storage device 202 to the generation apparatus 10, and receives various kinds of information from the generation apparatus 10.

The inside camera 204 captures the internal environment of the vehicle 20. The outside camera 205 captures the peripheral environment of the vehicle 20. The sound collecting microphone 206 collects a voice (the utterance contents of an occupant, or the like) uttered in the vehicle 20. The in-vehicle navigation device 207 includes a display unit 2071 and an operation input unit 2072. The display unit 2071 is a liquid crystal display or the like, and displays various kinds of navigation information such as route information from a departure place to a destination, or receives, from the generation apparatus 10, a moving plan (for example, an image or a video including a feature point on a route) generated by the generation apparatus 10 and displays it.

The operation input unit 2072 includes a physical button, a rotation mechanism, and the like. The driver (user) can operate the operation input unit 2072 to input various kinds of navigation information such as a departure place and a destination. Note that if the display unit 2071 is a touch panel, the display unit 2071 may function as the operation input unit 2072.

The communication apparatus 30 is, for example, a portable information terminal such as a smartphone. The communication apparatus 30 includes a CPU 301, a storage device 302, a communication unit 303, a display unit 304, and an operation input unit 305. The CPU 301 reads out a program stored in the storage device 302 and executes it, thereby controlling the operation of the communication apparatus 30. The storage device 302 stores the program to be read out and executed by the CPU 301, and also stores various kinds of information input to the communication apparatus 30 via the operation input unit 305. The communication unit 303 can communicate with the generation apparatus 10 via the network 40 and transmit/receive various kinds of information by wired or wireless communication. The communication unit 303 transmits various kinds of stored in the storage device 302 to the generation apparatus 10, and receives various kinds of information from:the generation apparatus 10.

The display unit 304 is a liquid crystal display or the like, and receives, from the generation apparatus 10, a moving plan (for example, an image or a video including a feature point on a route) generated by the generation apparatus 10 and displays it, or displays various kinds of screens. The operation input unit 305 includes a physical button, a rotation mechanism, and the like. The driver (user) can operate the operation input unit 305 to input various kinds of navigation information such as a departure place, a destination, a waypoint and a user ID. Note that if the display unit 304 is a touch panel, the display unit 304 may function as the operation input unit 305.

Before the user travels using the vehicle 20 of his/her own, navigation information is accepted from the user in advance using the communication apparatus 30. A moving plan (for example, an image or a video including a feature point on a route) of a route generated by the generation apparatus 10 based on the navigation information and the like can be seen via the display unit 304 of the communication apparatus 30. Accordingly, it is possible to know the state of the feature point on the route in advance by the video.

Note that the user may view the moving plan in advance via the communication apparatus 30, but may view the moving plan via the display unit 2071 of the in-vehicle navigation device 207 of the vehicle 20. That is, before the user travels using the vehicle 20 of his/her own, navigation information may be accepted from the user in advance using the in-vehicle navigation device 207 of the vehicle 20, and the moving plan of the route generated by the generation apparatus 10 may be received and displayed by the in-vehicle navigation device 207.

<Overall Processing>

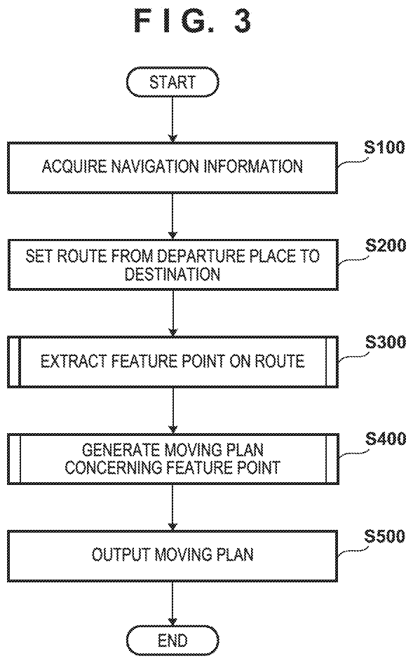

FIG. 3 is a flowchart showing the procedure of processing executed by the generation apparatus 10 according to this embodiment. This processing is executed by reading out a program stored in the storage device 102 and executing the program by the CPU 101 of the generation apparatus 10.

In step S100, the CPU 101 acquires various kinds of navigation information via the communication unit 103. Here, the navigation information is information input by the user who operates the operation input unit 2072 of the in-vehicle navigation device 207 or the operation input unit 305 of the communication apparatus 30 and transmitted to the generation apparatus 10. More specifically, the navigation information includes pieces of information such as a departure place and a destination, a scheduled departure date/time, a user ID, a waypoint, an expressway exclusion designation, and a vehicle tape.

In step S200, the CPU 101 sets a route from the departure place to the destination based on the navigation information acquired in step S100.

In step S300, the CPU 101 extracts information of feature points on the route set in step S200. Here, the feature points include caution points (for example, a first caution point where the driver readily takes a wrong road and a second caution point where an abrupt stop readily occurs) requiring attention at the time of driving. In addition, the feature points include points of interest (a first point of interest in which the user of the generation apparatus 10 is assumed to be interested and a second point of interest in which a user other than the user of the generation apparatus 10 is interested) which the driver is recommended to make a stop or pass at the time of driving. Note that not all of the first caution point, the second caution point, the first point of interest, and the second point of interest need be included. For example, one of the first caution point and the second caution point may be included. In addition, one of the first point of interest and the second point of interest may be included. Details of this step will be described later.

In step S400 the CPU 101 generates a moving plan (for example, an image: or a video including the feature points on the route) based on the one or more feature points extracted in step S300. Details of this step will be described later.

In step S500, the CPU 101 outputs, via the communication unit 103, the moving plan generated in step S400. The output destination is the in-vehicle navigation device 207 or the communication apparatus 30 that has output the navigation information to the generation apparatus 10 in step S100. The user can confirm the moving plan via the display unit 2071 of the in-vehicle navigation device 207 or the display unit 304 of the communication apparatus 30. The series of processes shown in FIG. 3 thus ends.

<Extraction Processing of Feature Points>

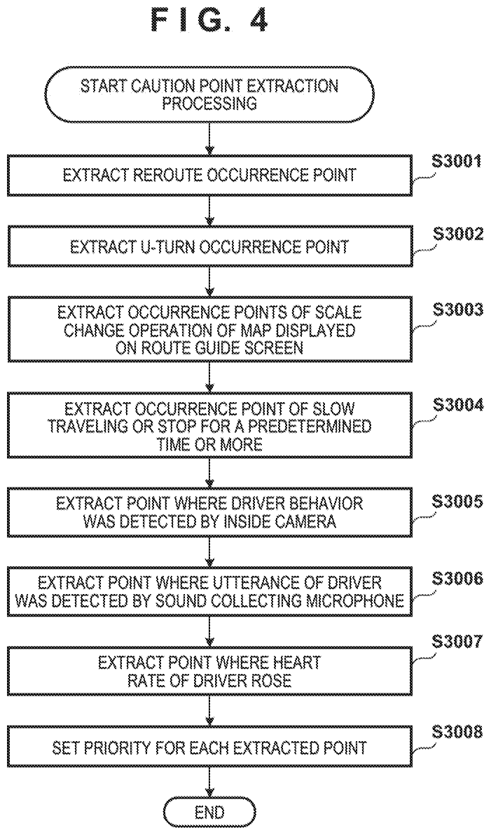

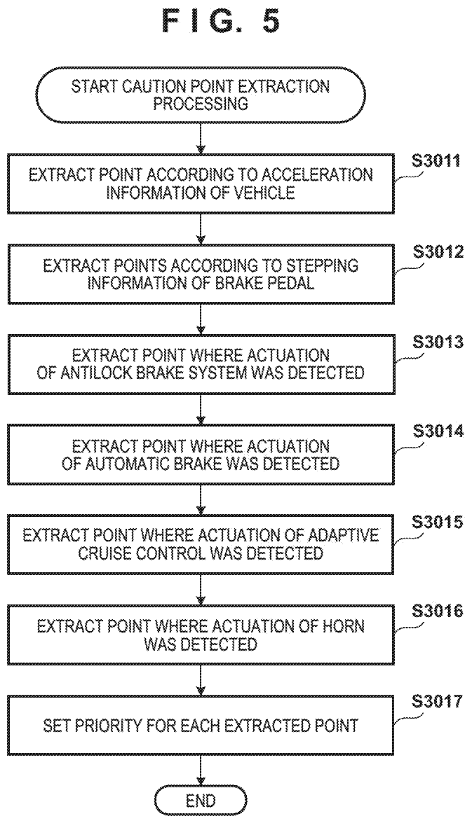

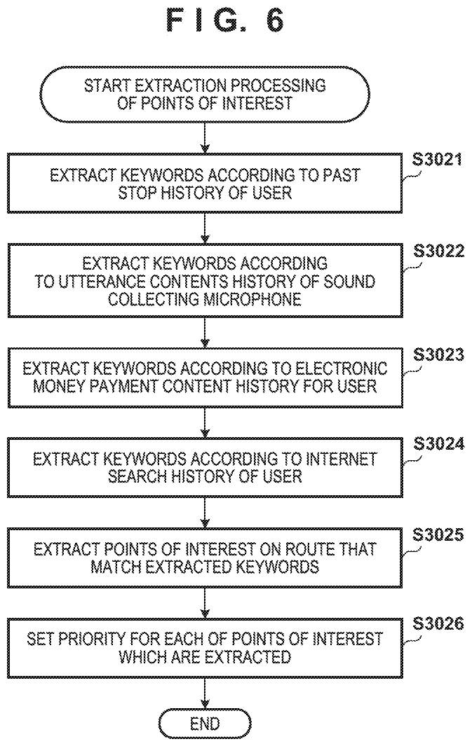

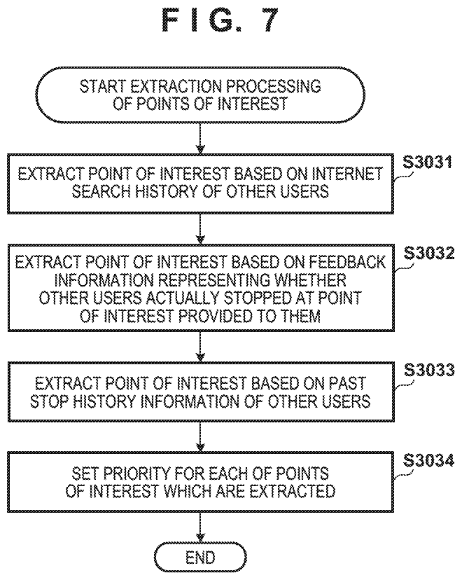

Details of extraction processing of feature points on the route in step S300 of FIG. 3 will be described next with reference to the flowcharts of FIGS. 4 to 7. FIGS. 4 and 5 are flowcharts concerning extraction processing of caution points requiring attention at the time of driving in the feature points. FIGS. 6 and 7 are flowcharts concerning extraction processing of points of interest which the driver is recommended to make a stop or pass at the time of driving in the feature points. Note that the processes shown in FIGS. 4 to 7 may be performed in parallel, or may be performed in turn. When performing the processes in turn, they can be performed in any order. In addition, not all the processes need be executed. For example, the processes shown in FIGS. 4 and 6 may be executed and ended.

[Wrong Road Taking Point Extraction Processing]

The procedure of processing of extracting the first caution point at which the driver readily takes a wrong road will be described first with reference to the flowchart of FIG. 4.

In step S3001, based on the traveling information (reroute occurrence information) of each vehicle 20, the CPU 101 extracts a point where a reroute occurred in the past as a cannon point where the driver readily takes a wrong road. The reroute here means that the route is reconstructed by the in-vehicle navigation device 207 in a state in which the destination or waypoint is not changed. A node immediately before the occurrence of the reroute can be determined as a reroute occurrence point. Note that the reroute occurrence information is transmitted to the generation apparatus 10 via the communication unit 203 of each vehicle 20 and stored in the storage device 102 of the generation apparatus 10. In this step, the CPU 101 extracts a past reroute occurrence point on the set route from the information of the reroute occurrence point stored in the storage device 102. Note that whether a point is a reroute occurrence point may be determined by the in-vehicle navigation device 207 of the vehicle 20, and the determination result may be transmitted to the generation apparatus 10. Alternatively, the determination may be done by the generation apparatus 10 that has acquired the traveling information (position information, speed information, and the like) of the vehicle 20 from the in-vehicle navigation device 207.

In step S3002, based on the traveling information (U-turn occurrence information) of each vehicle 20, the CPU 101 extracts a point where a U-turn occurred in the past as a caution point where the driver readily takes a wrong road. Based on the traveling information (position information, speed information, and the like) of each vehicle 20, if the vehicle passed a link and/r a node of a route twice in a short time (predetermined time), and moved in opposite directions in the first and second passages, the point can be determined as a U-turn occurrence point derived from a wrong road taken. Note that the U-turn occurrence information is transmitted to the generation apparatus 10 via the communication unit 203 of each vehicle 20 and stored in the storage device 102 of the generation apparatus 10. In this step, the CPU 101 extracts a past U-turn occurrence point on the set route from the information of the U-turn occurrence point stored in the storage device 102. Note that whether a point is a U-turn occurrence point may be determined by the in-vehicle navigation device 207 of the vehicle 20, and the determination result may be transmitted to the generation apparatus 10. Alternatively, the determination may be done by the generation apparatus 10 that has acquired the traveling information (position information, speed in formation, and the like) from the in-vehicle navigation device 207.

In step S3003, based on the traveling information (operation information concerning a scale change operation for a map displayed on a route guide screen) of each vehicle 20, the CPU 101 extracts a point where the scale change operation was performed in the past for the map displayed on the display unit 2071 of the in-vehicle navigation device 207 of the vehicle 20 as a caution point where the driver readily takes a wrong road. This is because it is considered that the scale change operation is performed because the road of the point is difficult to find in the guide of the in-vehicle navigation device 207, and the driver readily takes a wrong road at that point. Note that the occurrence information of the scale change operation is transmitted to the generation apparatus 10 via the communication unit 203 of each vehicle 20 and stored in the storage device 102 of the generation apparatus 10. In this step, the CPU 101 extracts a past scale change operation occurrence point on the set route from the information of the scale change operation occurrence point stored in the storage device 102. Note that whether a point is a scale change operation occurrence point may be determined by the in-vehicle navigation device 207 of the vehicle 20, and the determination result may be transmitted to the generation apparatus 10. Alternatively, the determination may be done by the generation apparatus 10 that has acquired the operation information concerning the scale change operation from the in-vehicle navigation device 207.

In step S3004, based on the traveling information(position information speed information, and the like) of each vehicle 20, the CPU 101 extracts a point where a predetermined number of vehicles 20 traveled slow or stopped for a predetermined time or more in the past as a caution point where the driver readily takes a wrong road. Note that the traveling information (position information, speed information, and the like) of each vehicle 20 is transmitted to the generation apparatus 10 via the communication unit 203 of each vehicle 20 and stored in the storage device 102 of the generation apparatus 10. Based on the traveling information (position information, speed information, and the like) of the vehicles 20 traveling an arbitrary point on the route at almost the same time, if vehicles 20 of a predetermined ratio of the vehicles 20 travel at a speed equal to the speed of slow traveling for the predetermined time, or vehicles 20 of the predetermined ratio stop the CPU 101 can determine the point as a caution point. However, if almost all vehicles 20 (in a predetermined number or more) travel slow or stop, the decrease in the speed is considered to be caused by a traffic signal, a railroad crossing, a traffic jam, or the like. Hence, the point may not be determined as a caution point.

In addition, based on the traveling information (position information and image capturing information of the outside camera 205), the presence/absence of a vehicle on the periphery, the color of a traffic signal, and the presence/absence of a railroad crossing can be determined from images captured by the outside camera 205. A point where a predetermined number of vehicles 20 traveled slow or stopped for a predetermined time or more in the past even if a traveling disturbance (a traffic signal, a railroad crossing, a traffic jam, or the like) was absent may be extracted as a caution point where the driver readily takes a wrong mad. For example, if slow traveling or stop occurs for a predetermined time or more in a situation in which no vehicle exists on the periphery, and a traffic signal does not indicate a stop signal, the point may be determined as a caution point where the driver readily takes a wrong road. In this step, the CPU 101 extracts a point where slow traveling or stop occurred on the set route for a predetermined time or more in the past as a caution point where the driver readily takes a wrong road.

In step S3005, based on the traveling information (position information and image capturing information of the inside camera 204) of each vehicle 20, the CPU 101 extracts a point where a predetermined behavior of the driver was detected in the past as a caution point where the driver readily takes a wrong road. The predetermined behavior is the behavior of the driver looking around, gazing the screen of the in-vehicle navigation device 207 for a predetermined time or more, or operating the screen of the communication apparatus 30 for a predetermined time or more. This is because it is considered that if these behaviors are detected, the road is difficult to find, or the driver gets lost and slowly drives or stops the vehicle. The predetermined behavior can be detected by analyzing images captured by the inside camera 204 of each vehicle 20. Note that the detection of the predetermined behavior may be performed in each vehicle 20, or may be performed by the generation apparatus 10 that has acquired the captured images from each vehicle 20. The information of the detection result of the predetermined behavior is stored in the storage device 102 of the generation apparatus 10. In this step, the CPU 101 extracts a point where the predetermined behavior was detected on the set route in the past as a caution point where the driver readily takes a wrong road.

In step S3006, based on the traveling information (position information and sound collection information of the sound collecting microphone 206) of each vehicle 20, the CPU 101 extracts a point where a predetermined utterance of the driver was detected as a caution point where the driver readily takes a wrong road. The predetermined utterance is a filler (a word such as “eh”, “well” or “uh” inserted in a conversation) or a keyword such as “made a mistake”. This is because it is considered that if these utterances are detected, the mad is difficult to find, or the driver gets lost and stops the vehicle. The predetermined utterance can be detected by analyzing voice information collected by the sound collecting microphone 206 of each vehicle 20. Note that the detection of the predetermined utterance may be performed in each vehicle 20, or may be performed by the generation apparatus 10 that has acquired the voice information from each vehicle 20. The information of the detection result of the predetermined utterance is stored in the storage device 102 of the generation apparatus 10. In this step, the CPU 101 extracts a point where the predetermined utterance was detected on the set route in the past as a caution point where the driver readily takes a wrong road.

In step S3007, based on the traveling information (position information and heart rate information) of each vehicle 20, the CPU 101 extracts a point where the heart rate of the driver rose in the past as a caution point where the driver readily takes a wrong road. This is because it is considered that the road is difficult to find, or the driver gets lost at a point where the heart rate of the driver wearing a heart rate measuring device (not shown) abruptly rises. If a difference equal to or more than a threshold is generated between the heart rate at the first time and the heart rate at the second time later than the first time, it can be determined that the heart rate has abruptly risen. The measurement data of the heart rate measuring device may be output to the vehicle 20, and the vehicle 20 may determine the heart rate rising point based on the measurement data and the traveling information (position information and the like) of the vehicle 20. Alternatively, the measurement data and the traveling information of the vehicle 20 may be transmitted to the generation apparatus 10, and the generation apparatus 10 may determine the heart rate rising point. The information of the determined heart rate rising point is stored in the storage device 102 of the generation apparatus 10. In this step, the CPU 101 extracts a point where the heart rate of the driver rose on the set route m the past as a caution point where the driver readily takes a wrong road.

In step S3008, the CPU 101 sets a priority for each of the caution points on the route, which are extracted in steps 53001 to S3007. More specifically, a high priority is set in descending order of extraction count. For example, if a caution point A is extracted in all of steps S3001 to S3007, the extraction count of the caution point A is 7, and therefore, the priority of the caution point A is 7. Similarly, if a caution point B is extracted in steps S3001 and S3002, and the caution point B is not extracted in steps 53003 to 53007, the extraction count of the caution point B is 2, and therefore, the priority of the caution point B is 2. Similar processing is performed for each caution point, thereby setting a priority for each caution point. The information of the priority set in this step is used when generating a moving plan.

The series of processes shown in FIG. 4 thus ends. According to the series of processes, the first caution point where the driver readily takes a wrong road can be extracted with a priority to give a caution.

Note that the order of the processes of steps S3001 to S3007 is not limited to the illustrated example, and the order may be changed. In addition, some steps may be skipped.

[Abrupt Stop Occurrence Point Extraction Processing]

The procedure of processing of extracting the second caution point at which an abrupt stop readily occurs will be described next with reference to the flowchart of FIG. 5.

In step S3011, the CPU 101 extracts, as a caution point, an abrupt stop occurrence point determined based on the traveling information (position information, acceleration information,:and the like) of each vehicle 20. More specifically the value of the acceleration at the time of deceleration is acquired based on the traveling information (position information and acceleration information) of the vehicle 20. If the magnitude of the acceleration is equal to or more than a threshold (for example, 0.5 G), the point where the deceleration occurs can be determined as an abrupt stop occurrence point. Note that the threshold may be configured to be arbitrarily changeable depending on the type of the vehicle 20. The abrupt stop occurrence point may be determined by each vehicle 20, and the determination result may be transmitted to the generation apparatus 10. Alternatively, the determination may be done by the generation apparatus 10 that has acquired the traveling information (position information and acceleration information) of each vehicle 20. The information of the determined abrupt stop occurrence point is stored in the storage device 102 of the generation apparatus 10. In this step, the CPU 101 extracts a past abrupt stop occurrence point based on acceleration :information, which exists on the set route, as a caution point where an abrupt stop readily occurs.

In step S3012, the CPU 101 extracts, as a caution point, an abrupt stop occurrence point determined based on the traveling information (position information and information of the stepping amount of the brake pedal) of each vehicle 20. More specifically, based on the traveling information (position information and information of the stepping amount of the brake pedal) of the vehicle 20, if the stepping amount of the brake pedal is equal to or more than a threshold, the point where the stepping occurs can be determined as an abrupt stop occurrence point. Note that the threshold may be configured to be arbitrarily changeable depending on the type of the vehicle 20. The abrupt stop occurrence point may be determined by each vehicle 20, and the determination result may be transmitted to the generation apparatus 10. Alternatively, the determination may be done by the generation apparatus 10 that has acquired the traveling information (position information and information of the stepping amount of the brake pedal) of each vehicle 20. The information of the determined abrupt stop occurrence point is stored in the storage device 102 of the generation apparatus 10. In this step, the CPU 101 extracts a past abrupt stop occurrence point based on the stepping amount of the brake pedal, which exists on the set route, as a caution point where an abrupt stop readily occurs.

In step S3013, the CPU 101 extracts, as a caution point, an abrupt stop occurrence point determined based on the traveling information (position information and actuation information of the anti-lock brake system (ABS)) of each vehicle 20. More specifically, based on the traveling information (position information and actuation information of the ABS) of the vehicle 20, the point where the ABS is actuated can be determined as an abrupt stop occurrence point. The abrupt stop occurrence point may be determined by each vehicle 20, and the determination result may be transmitted to the generation apparatus 10. Alternatively, the determination may be done by the generation apparatus 10 that has acquired the traveling information (position information and actuation information of the ABS) of each vehicle 20. The information of the determined abrupt stop occurrence point is stored in the storage device 102 of the generation apparatus 10. In this step, the CPU 101 extracts a past abrupt stop occurrence point based on ABS actuation, which exists on the set route, as a caution point where an abrupt stop readily occurs.

In step S3014, the CPU 101 extracts, as a caution point, an abrupt stop occurrence point determined based on the traveling information (position information and actuation information of the automatic brake) of each vehicle 20. More specifically, based on the traveling information (position information and actuation information of the automatic brake) of the vehicle 20, the point where the automatic brake is actuated can be determined is an abrupt stop occurrence point. The abrupt stop occurrence point may be determined by each vehicle 20, and the determination result ma be transmitted to the generation apparatus 10. Alternatively, the determination may be done by the generation apparatus 10 that has acquired the traveling information (position information and actuation information of the automatic brake) of each vehicle 20. The information of the determined abrupt stop occurrence point is stored in the storage device 102 of the generation apparatus 10. In this step, the CPU 101 extracts a past abrupt stop occurrence point based on automatic brake actuation, which exists on the set route, as a caution point where an abrupt stop readily occurs.

In step S3015, the CPU 101 extracts, as a caution point, an abrupt stop occurrence point determined based on the traveling information (position information and actuation information of the adaptive cruise control) of each vehicle 20. More specifically, based on the traveling information (position information and actuation information of the ACC) of the vehicle 20, the point where the brake is actuated due to a decrease in the following distance under the automatic inter-vehicle distance control by the ACC can be determined as an abrupt stop occurrence point. The abrupt stop occurrence point may be determined by each vehicle 20, and the determination result may be transmitted to the generation apparatus 10. Alternatively, the determination may be done by the generation apparatus 10 that has acquired the traveling information (position information and actuation information of the ACC) of each vehicle 20. The information of the determined abrupt stop occurrence point is stored in the storage device 102 of the generation apparatus 10. In this step, the CPU 101 extracts a past abrupt stop occurrence point based on ACC actuation, which exists on the set route, as a caution point where an abrupt stop readily occurs.

In step S3016, the CPU 101 extracts, as a caution point, an abrupt stop occurrence point determined based on the traveling information (position information and actuation information of the horn) of each vehicle 20. More specifically, based on the traveling information position information and actuation information of the horn) of the vehicle 20, the point where the horn is actuated can be determined as an abrupt stop occurrence point. The abrupt stop occurrence point may be determined by each vehicle 20, and the determination result may be transmitted to the generation apparatus 10. Alternatively, the determination may be done by the generation apparatus 10 that has acquired the traveling information position information and actuation information of the horn) of each vehicle 20. The information of the determined abrupt stop occurrence point is stored in the storage device 102 of the generation apparatus 10. In this step, the CPU 101 extracts a past abrupt stop occurrence point based on horn actuation, which exists on the set route, as a caution point where an abrupt stop readily occurs.

In step S3017, the CPU 101 sets a priority for each of the caution points on the route, which are extracted in steps S3011 to S3016. More specifically, a high priority is set in descending order of extraction count. The priority setting method is similar to the setting method described concerning step S3008, and a description thereof will be omitted. As in step S3008, the information of the priority set in this step is used when generating a moving plan.

The series of processes shown in FIG. 5 thus ends. According to the series of processes, the second caution point where an abrupt stop readily occurs can be extracted with a priority to give a caution.

Note that the order of the processes of steps S3011 to S3016 is not limited to the illustrated example, and the order may be changed. In addition, some steps may be skipped.

[Point-Of-Interest Extraction Processing Based on Interest/Preference of User]

The procedure of processing of extracting the first point of interest in which the user of the generation apparatus 10 is assumed to be interested will be described next with reference to the flowchart of FIG. 6.

In step S3021, based on the traveling information (ignition-off point) of the vehicle 20 of the user, the CPU 101 extracts a keyword from the past stop history of the user. More specifically, based on the traveling information (position information and the ignition-off point) of the user, a keyword the user is interested in prefers is extracted from the history of stop at a tourist spot, a leisure facility, a restaurant, a commercial facility, and the like. If the user is communicating with the generation apparatus 10 using the communication unit 303 of the communication apparatus 30, the ID information of the user is transmitted to the generation apparatus 10 via the communication unit 303. Hence, the CPU 101 can access the traveling information (position information and ignition-off point) of the vehicle 20 of the user stored in the storage device 102. Alternatively, if the user is communicating with the generation apparatus 10 using the communication unit 203 of the vehicle 20, the ID information of the user is transmitted to the generation apparatus 10 via the communication unit 203. Hence, the CPU 101 can access the traveling information (position information and ignition-off point) of the user stored in the storage device 102.

In step S3022, based on the traveling information (history information of the utterance contents of the user) of the vehicle 20 of the user, the CPU 101 extracts a keyword from the past utterance contents history acquired by the sound collecting microphone 206. More specifically, the utterance contents in the vehicle during traveling are analyzed based on the traveling information position information and the utterance contents) of the user. Then, a keyword the user is interested in/prefers is extracted from the response contents (acknowledgement response/agreement response) of the user to contents uttered by the passenger. If the user is communicating with the generation apparatus 10 using the communication unit 303 of the communication apparatus 30, the ID information of the user is transmitted to the generation apparatus 10 via the communication unit 303. Hence, the CPU 101 can access the traveling information (position information and history information of the utterance contents) of the vehicle 20 of the user stored in the storage device 102. Alternatively, if the user is communicating with the generation apparatus 10 using the communication unit 203 of the vehicle 20, the ID information of the user is transmitted to the generation apparatus 10 via the communication unit 203. Hence, the CPU 101 can access the traveling information (position information and history information of the utterance contents) of the user stored in the storage device 102.

In step S3023, the CPU 101 extracts a keyword from the past payment content history information of electronic money by the user. More specifically, information of a store where an article was purchased, information of a facility where a service was used, and the like are acquired, and a keyword such as a store name or a facility name is extracted as a keyword the user is interested in/prefers. Note that the history of the payment contents of the electronic money is stored in the storage device 302 of the communication apparatus 30 held by the user. If the user is communicating with the generation apparatus 10 using the communication unit 303 of the communication apparatus 30, the history information of the payment contents of the electronic money of the user is transmitted to the generation apparatus 10 via the communication unit 303, whereby the CPU 101 can acquire the history information of the payment contents of the electronic money of the user.

In step S3024, the CPU 101 extracts a keyword from the search history of the Internet by the user. More specifically, a keyword recently often used for a search or browsing is extracted from the search history or browsing history of the Internet by the user. Note that the search history and the browsing history of the Internet are stored in the storage device 302 of the communication apparatus 30 or the vehicle 20 of the user. The user can access the Internet by operating the communication apparatus 30, or can also access the Internet by operating the in-vehicle navigation device 207 of the vehicle 20. If the user is communicating with the generation apparatus 10 using the communication unit 303 of the communication apparatus 30, the Internet search history information of the user is transmitted to the generation apparatus 10 via the communication unit 303, whereby the CPU 101 can acquire the Internet search history information of the user. If the user is communicating with the generation apparatus 10 using the communication unit 203 of the vehicle 20, the Interent search history information of the user is transmitted to the generation apparatus 10 via the in-vehicle navigation device 207, whereby the CPU 101 can acquire the Internet search history information of the user.

In step S3025, the CPU 101 extracts, as points of interest, points on the set route that are coincident with or similar to the keywords extracted in steps S3021 to S3024.

In step S3026, the CPU 101 sets a priority for each of the points of interest on the route, which are extracted in step S3025. More specifically, a high priority is set in descending order of extraction count. The priority setting method is similar to the setting method described concerning step S3008, and a description thereof will be omitted. As in step S3008, the information of the priority set in this step is used when generating a moving plan.

The series of processes shown in FIG. 6 thus ends. According to the series of processes, the first point of interest in which the user is assumed to be interested can be extracted with a priority.

Note that the order of the processes of steps S3021 to S3024 is not limited to the illustrated example, and the order be changed. In addition, some steps may be skipped.

[Point-Of-Interest Extraction Processing Based on Interest/Preference of Other Users]

The procedure of processing of extracting the second point of interest in which other users other than the user of the generation apparatus 10 are interested be described next with reference to the flowchart of FIG. 7. Other users here mean other users who use the vehicles 20 or general users of the Inter et other than the user who is going to acquire a moving plan using the generation apparatus 10.

In step S3031, the CPU 101 extracts a keyword from the search history of the Internet by other users, and extracts a point of interest that is coincident with or similar to the keyword. More specifically, a keyword recently often used for a search or browsing is extracted from the search history or browsing history of the Internet by the other users. Note that the search history and the browsing history of the Internet are stored in the storage devices 302 of the communication apparatuses 30 held by the other users or the vehicles 20 of the other users. The other users can each access the Internet by operating the communication apparatus 30, or can also access the Internet by operating the in-vehicle navigation device 207 of the vehicle 20. Note that the other users here need not always be the users of the vehicles 20, and may be users in a wide range who widely generally use the Internet, as described above. In this case, the CPU 101 may extract a keyword from the general search history of the Internet.

In step S3032, the CPU 101 extracts a point of interest based on feedback information representing whether other users actually made a stop at a point of interest provided to them. More specifically, concerning the information of a point of interest provided to the other users in the past, feedback information representing whether the other users actually made a stop at the point of interest is acquired, and the number of users ho actually made a stop is counted. Then, a point of interest for which the count is equal to or more than a threshold is extracted. Here, the feedback information can be acquired by accepting it via the communication apparatuses 30 of the other users or the in-vehicle navigation devices 207 of the vehicles 20. Alternatively, the feedback information may be acquired by determining, by the generation apparatus 10, whether a user actually made a stop based on the traveling information (position information of the ignition-off point) of each vehicle 20 and the information of a point of interest provided before traveling.

porn In step S3033, the CPU 101 extracts a point of interest based on the past stop history of other users. More specifically, based on the traveling information (position information of the ignition-off point) of the other users, the number of users who made a stop at each point is counted from the history of stop at a tourist spot, a leisure facility, a restaurant, a commercial facility and the like. Then, a point for which the count is equal to or more than a threshold is extracted as a point of interest. The traveling information (position information of the ignition-off point) of each vehicle 20 is transmitted from the vehicle 20 to the generation apparatus 10 and stored in the storage device 102 of the generation apparatus 10. The CPU 101 can access the traveling information (position information of the ignition-off point) of the other users stored in the storage device 102.

In step S3034, the CPU 101 sets a priority for each of the points of interest on the route, which are extracted in steps S3031 to S3033. More specifically, a high priority is set in descending order of extraction count. The priority setting method is similar to the setting method described concerning step S3008, and a description thereof will be omitted. As in step S3008, the information of the priority set in this step is used when generating a moving plan.

The series of processes shown in FIG. 7 thus ends. According to the series of processes the second point of interest in which the other users are interested can be extracted with a priority.

Note that the order of the processes of steps S3031 to S3033 is not limited to the illustrated example, and the order may be changed. In addition, some steps may be skipped.

<Moving Plan Generation Processing>

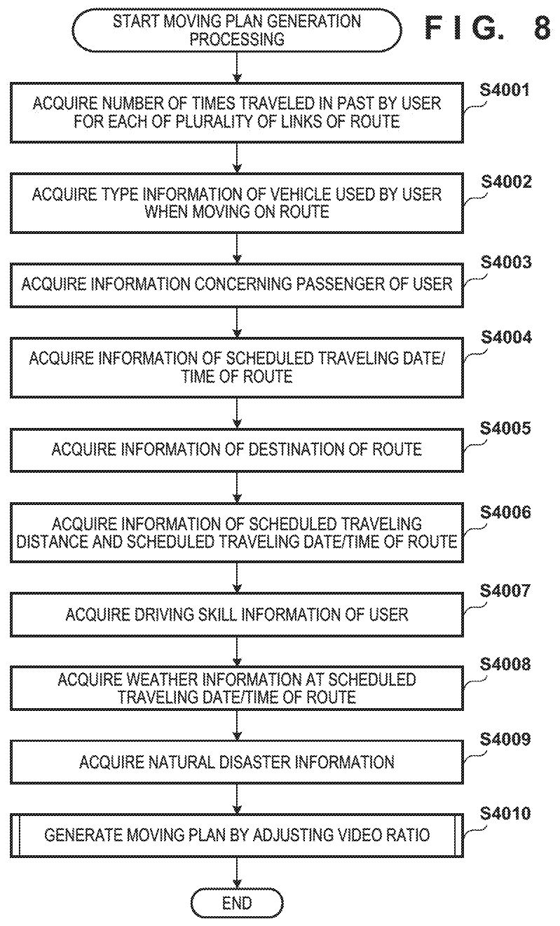

Details of step S400 (generation processing of a moving plan concerning a feature point) of FIG. 3 will be described next with reference to the flowchart of FIG. 8.

In step S4001, the CPU 101 acquires the number of times of traveling by the user in the past as the profile information of the user for each link of the route from the departure place to the destination set in step S200. The profile information is calculated in advance from the traveling information of the vehicle 20 of the user and stored in the storage device 102 of the generation apparatus 10. The calculation may be performed by the vehicle 20 of the user or may be performed by the generation apparatus 10.

In step S4002, the CPU 101 acquires the type information (for example, four-wheeled vehicle or two-wheeled vehicle) of a vehicle scheduled to be used by the user when moving on the route as the profile information of the user. If the user is communicating with the generation apparatus 10 using the communication apparatus 30 or the in-vehicle navigation device 207 of the vehicle 20, the user ID is transmitted using the communication apparatus 30 or the in-vehicle navigation device 207 of the vehicle 20. Since the user ID and the type information of the vehicle 20 to be used by the user are stored in the storage device 102 of the generation apparatus 10 in association with each other, the CPU 101 can acquire: the type information of the vehicle :scheduled to be used by the user. Alternatively, the type information of the vehicle may be input by the user and transmitted to the generation apparatus 10 via the communication apparatus 30 or the in-vehicle navigation device 207 of the vehicle 20, whereby the generation apparatus 10 may acquire the type information.

In step S4003, the CPU 101 acquires information concerning a passenger of the user as the profile information of the user. For example, the CPU 101 acquires information representing the presence/absence of a passenger, and if a passenger exists, attribute information (for example, family, boyfriend/girlfriend, friend who frequently rides together, acquaintance, or the like) of the passenger. The information concerning the passenger is input by the user who uses the communication apparatus 30 or the in-vehicle navigation device 207 of the vehicle 20 and transmitted to the generation apparatus 10, whereby the generation apparatus 10 can acquire the information. The information concerning the passenger may be acquired by inputting it together in step S100 of FIG. 3.

In step S4004, the CPU 101 acquires the information of the scheduled traveling date/time of the route as the profile information of the user. If the information is input as part of the navigation information in step S100 of FIG. 3, the information may be acquired from the navigation information. Alternatively, in this step, the information may be directly input by the user who uses the communication apparatus 30 or the in-vehicle navigation device 207 of the vehicle 20 and transmitted to the generation apparatus 10, whereby the generation apparatus 10 may acquire the information.

In step S4005, the CPU 101 acquires the information of the destination of the route as the profile information of the user. The information can be acquired from information input as part of the navigation information in step S100 of FIG. 3.

In step S4006, the CPU 101 acquires the information of the scheduled travel distance and the scheduled traveling date/time of the mute as the profile information of the user. The information is acquired by calculating by the CPU 101, based on the departure place and the destination input as part of the navigation information in step S100 of FIG. 3. Alternatively, the generation apparatus 10 may transmit the information of the departure place and the destination to an external navigation device (not shown) that communicates with the generation apparatus 10, and receive information calculated by the external navigation device, thereby acquiring the information.

In step S4007, the CPU 101 acquires driving skill information (for example, information representing whether the driving skill is high) of the user as the profile information of the user. In step S100 of FIG. 3, the user transmits the user ID to the generation apparatus 10 via the communication apparatus 30 or the vehicle 20. The past traveling information (acceleration/deceleration, steering operation, brake operation, occurrence of reroute or U-turn, and the like) of the user is transmitted from the vehicle 20 to the generation apparatus 10 and stored in the storage device 102 of the generation apparatus 10. The CPU 101 counts the number of times of taking a wrong road, the number of abrupt stops, the number of steep turns, and the like based on the past traveling information of the user. If the number of times of taking a wrong road is equal to or less than a threshold, it may be determined that the driving skill is high. If the number of abrupt stops is equal to or less than a threshold, it may be determined that the driving skill is high. If the number of steep turns is equal to or less than a threshold, it may be determined that the driving skill is high. Alternatively, if all the conditions are satisfied, it may be determined that the driving skill is high. Other conditions may be combined as a matter of course. Alternatively, the user may input, by himself/herself, information representing whether he/she has confidence in the driving skill to the generation apparatus 10, thereby acquiring the driving skill information of the user.

In step S4008, the CPU 101 acquires weather information at the scheduled traveling date/time of the route as the profile information of the user. The weather information on the route (or on the periphery of the route) is acquired from the Internet using the communication unit 103. Note that if the information of the scheduled traveling date/time of the route is input as part of the navigation information in step S100 of FIG. 3, the information of the scheduled traveling date/time may be acquired from the navigation information. Alternatively, in this step, the information may be input by the user who uses the communication apparatus 30 or the in-vehicle navigation device 207 of the vehicle 20 and transmitted to the generation apparatus 10, whereby the generation apparatus 10 may acquire the information. If the information is already acquired in step S4004, the information may be used.

In step S4009, the CPU 101 acquires natural disaster information of the route as the profile information of the user. The natural disaster information on the route (or on the periphery of the route) is acquired from the Internet using the communication unit 103. The natural disaster information is, for example, an advisory or warning, landslide information upon heavy rain, river flooding information, volcanic eruption information, and road surface freeze information.

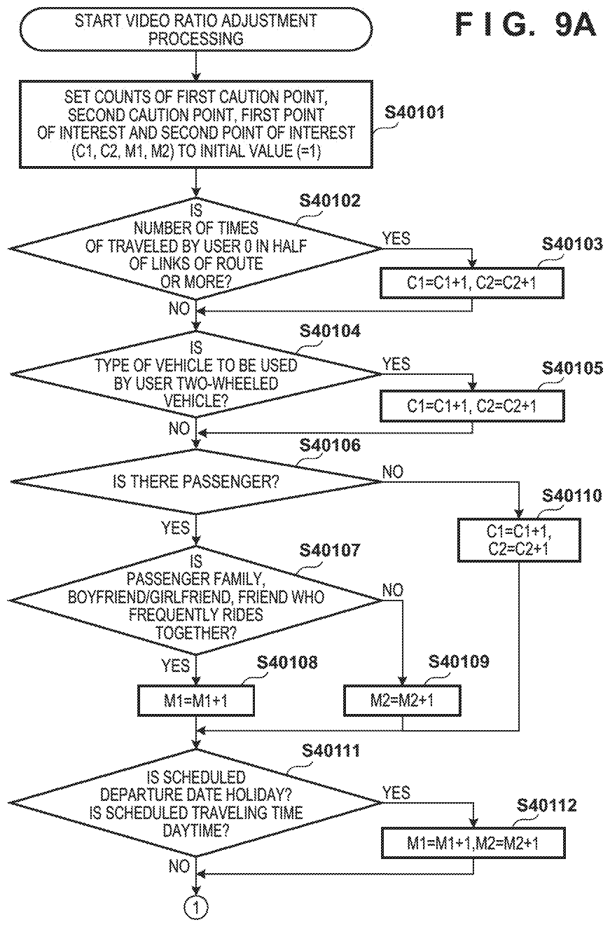

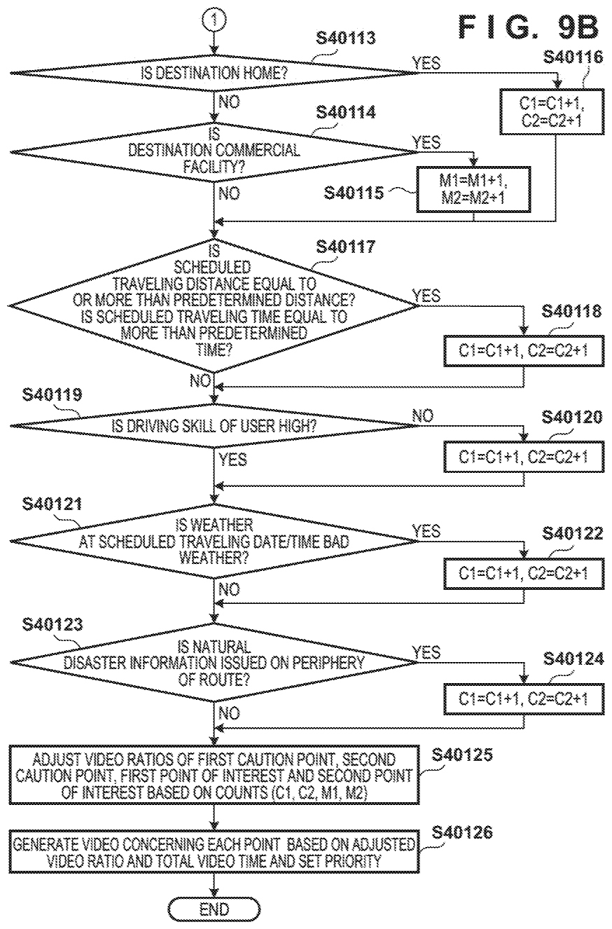

In step S4010, the CPU 101 adjusts a video ratio concerning a feature point (caution point or point of interest) based on the various kinds of profile information acquired in steps S4001 to S4009, thereby generating a moving plan. Details of this step will be described later with reference to FIGS. 9A and 9B.

The series of processes shown in FIG. 8 thus ends. According to the series of processes, a moving plan more appropriate for the user can be generated in consideration of various factors.

Note that the order of the processes of steps S4001 to S4009 is not limited to the illustrated example, and the order may be changed. In addition, some steps may be skipped.

<Video Ratio Adjustment Processing>

Details of step S4010 (processing of generating a moving, plan by adjusting the video ratio) of FIG. 8 will be described next with reference to the flowchart of FIGS. 9A and 9B.

In step S40101, the CPU 101 defines counts C1, C2, M1, and M2 for the first caution point (a point where the driver readily takes a wrong road) extracted in accordance with the flowchart of FIG. 4, the second caution point (a point where an abrupt stop readily occurs) extracted in accordance with the flowchart of FIG. 5, the first point of interest (a point in which the user is assumed to be interested) extracted in accordance with the flowchart of FIG. 6, and the second point of interest (a point in which other users are interested) extracted in accordance with the flowchart of FIG. 7, respectively, and sets initial value (=1) for each value. That is, C1=1, C2=1, M1=1, and M2=1 are set.

In step S40102, the CPU 101 determines, based on the information of the number of times of traveling acquired in step S4001 of FIG. 8, whether the number of times of traveling by the user is 0 in a half or more of the links of the set route. If YES in this step, the process advances to step S40103. On the other hand, if NO in this step, the process advances to step S40104. Note that an example in which the determination is done based on whether “a half or more” in this step has been described. However, the number is not limited to a half An arbitrary predetermined number may be set, and the magnitude relationship to the predetermined number may be determined,

In step S4010, the CPU 101 increments the count C1 of the first caution point and the count C2 of the second caution point. If the number of times of traveling is 0 in a half or more of the links of the route, the traveling experience on the route is poor, and more careful traveling can be promoted. Hence, to make the ratio of caution points higher than that of points of interest, the counts of the caution points are incremented. After that, the process advances to step S40104.

In step S40104, the CPU 101 determines, based on the type information of the vehicle acquired in step S4002 of FIG. 8, whether the type of the vehicle 20 to be used by the user is a two-wheeled vehicle. If YES in this step, the process advances to step S40105. On the other hand, if NO in this step, the process advances to step S40106.

In step S40105, the CPU 101 increments the count C1 of the first caution point and the count C2 of the second caution point. More careful traveling can be promoted for the two-wheeled vehicle than a four-wheeled vehicle. Hence, to make the ratio of caution points higher than that of points of interest, the counts of the caution points are incremented. After that, the process advances to step S40106.

In step S40106, the CPU 101 determines, based on the information concerning a passenger of the user acquired in step S4003 of FIG. 8, whether a passenger exists. If YES in this step, the process advances to step S40107. On the other hand, if NO in this step, the process advances to step S40110.

In step S40107, the CPU 101 determines, based on the information concerning a passenger of the user acquired in step S4003 of FIG. 8, whether the passenger is a person (family, boyfriend/girlfriend, friend who frequently rides together, or the like) in close relationship with the user. If YES in this step, the process advances to step S40108. On the other hand, if NO in this step, the process advances to step S40109. Note that if a plurality of passengers exist, it may be determined whether the total number S1 of the user and passengers in close relationship with the user is equal to or larger than the total number S2 of passengers who are not in dose relationship with the user. If S1 is equal to or larger than S2, the process may advance to step S40108. If S1 is less than S2, the process may advance to step S40109. For example, assume a case in which four passengers exist, two of them are persons in close relationship with the user, and two of them are persons not in close relationship with the user. In this case, S1 is 3 that is the total number of the user and persons in close relationship, and S2 is 2 that is the total number of persons not in close relationship. In this case, since S1 (=3)>S2 (=2), the process advances to step S40108. If S1=S2, priority may be given to the interest of the user, and the process may advance to step S40108.

In step S40108, the CPU 101 increments the count M1 of the first point of interest. In a case of a passenger in close relationship with the user, the count is incremented to make the ratio of points of interest in which the user is assumed to be interested higher. After that, the process advances to step S40111.

In step S40109, the CPU 101 increments the count M2 of the second point of interest. In a case of a passenger not in close relationship with the user, the count is incremented to make the ratio of points of interest in which other users are assumed to be generally interested higher in consideration of the passenger. After that, the process advances to step S40111.

In step S40110, the CPU 101 increments the count C1 of the first caution point and the count C2 of the second caution point. If no passenger exists, the user cannot receive driving assist from a passenger. Hence, to make the ratio of caution points higher than that of points of interest, the counts of the caution points are incremented. After that, the process advances to step S40111.

By the processes of steps S40106 to S40110, it is possible to provide a more appropriate point in accordance with the presence/absence of a passenger or attribute information (information representing whether a passenger is in close relationship with, the user).

Next, in step S40111, the CPU 101 determines, based on the information of the scheduled traveling date/time of the route acquired in step S4004 of FIG. 8, whether the scheduled departure date is a holiday and/or whether the scheduled traveling time (a time zone to travel up to the destination) is daytime. Here, the holiday may include the Bon period, the New Year period, and the like in addition to Saturday, Sunday, and holidays. In addition, daytime is a time zone in which the sun is up. If at least one of the conditions is satisfied, this step ends with YES. If YES in this step, the process advances to step S40112. On the other hand, if NO in this step, the process advances to step S40113.

In step S40112, the CPU 101 increments the count M1 of the first point of interest and the count M2 of the second point of interest. If the scheduled departure date is a holiday, the user may want to make a stop at any point of interest before the arrival at the destination. Hence, the counts are incremented to make the ratio of points of interest higher than that of the caution points. In addition, if the scheduled traveling time is daytime, the visibility on the road is high. Hence, the counts are incremented to make the ratio of points of interest higher than that of the caution points. After that, the process advances to step S40113.

In step S40113, the CPU 101 determines, based on the information of the destination of the route acquired in step S4005 of FIG. 8, whether the destination is the user's home. If YES in this step, the process advances to step S40116. On the other hand, if NO in this step, the process advances to step S40114.

In step S40114, the CPU 101 determines, based on the information of the destination of the route acquired in step S4005 of FIG. 8, whether the destination is a commercial facility. Note that whether the destination is a commercial facility is determined based on the traveling information (the position information of the ignition-off point) of the vehicles 20 of other riser on the periphery of the destination. For example, the number of times of making a stop is counted from the stop history for the destination, and if the count is statistically high (for example, if the count is equal to or more than a threshold), the destination can he determined as a commercial facility Alternatively, the input destination information may be collated with a navigation map and if the destination corresponds to a commercial facility registered on the navigation map, the destination may be determined as a commercial facility. If YES in this step, the process advances to step S40115. On the other hand, if NO in this step, the process advances to step S40117.

In step S40115, the CPU 101 increments the count M1 of the first point of interest and the count M2 of the second point of interest. If the destination is a commercial facility, the counts are incremented to make the ratio of points of interest higher. After that, the process advances to step S40117.

In step S40116, the CPU 101 increments the count Cl of the first caution point and the count C2 of the second caution point. If the destination is the home, it is assumed that the driver is on his/her way home. The counts of the caution points are incremented to make the ratio of caution points higher than that of points of interest in consideration of fatigue and the like. After that, the process advances to step S40117.

In step S40117, the CPU 101 determines, based on the information of the scheduled traveling distance and the scheduled traveling time of the route acquired in step S4006 of FIG. 8, whether the scheduled traveling distance is equal to or more than a predetermined distance (for example, 50 km) and/or whether the scheduled traveling time (a time needed to arrive at the destination) is equal to or more than a predetermined time (for example, 2 hrs). Note that the predetermined distance and the predetermined tune are not limited to the examples, and arbitrary values can be set. If at least one of the conditions is satisfied, this step ends with YES. If YES in this step, the process advances to step S40118. On the other hand, if NO in this step, the process advances to step S40119.

In step S40118, the CPU 101 increments the count C1 of the first caution point and the count C2 of the second caution point. If the distance up to the destination is long, or if the driving time is long, the counts of the caution points are incremented to make the ratio of caution points higher than that of points of interest in consideration of fatigue and the like. After that, the process advances to step S40118.

In step S40119, the CPU 101 determines, based on the driving skill information (for example, information representing whether the driving skill of the user is high) of the user acquired in step S4007 of FIG. 8, whether the driving skill of the user is high. If YES in this step, the process advances to step S40121. On the other hand, if NO in this step, the process advances to step S40120.

In step S40120, the CPU 101 increments the count C1 of the first caution point and the count C2 of the second caution point. If the driving skill of the user is not high, the counts of the caution points are incremented to make the ratio of caution points higher than that of points of interest. After that, the process advances to step S40121.

In step S40121, the CPU 101 determines, based, on the weather information at the scheduled traveling date/time of the route acquired in step S4008 of FIG. 8, whether the weather of the route at the scheduled traveling date/time is a bad weather (for example, heavy rain, snow, dense fog, or the like). If YES in this step, the process advances to step S40122. On the other hand, if NO in this step, the process advances to step S40123.

In step S40122, the CPU 101 increments the count C1 of the first caution point and the count C2 of the second caution point. If the weather of the route is a bad weather, the counts of the caution points are incremented to make the ratio of caution points higher than that of points of interest. After that, the process advances to step S40123.

In step S40123, the CPU 101 determines, based on the natural disaster information acquired in step S4009 of FIG. 8, whether there is an announcement of information on a natural disaster on the route or in the periphery of the route. If YES in this step, the process advances to step S40124. On the other hand, if NO in this step, the process advances to step S40125.

In step S40124, the CPU 101 increments the count C1 of the first caution point and the count C2 of the second caution point. If there is an announcement of information on a natural disaster on the route or in the periphery of the route, the counts of the caution points are incremented to make the ratio of caution points higher than that of points of interest. After that, the process advances to step S40125.

In step S40125, the CPU 101 adjusts the video ratios of the first caution point, the second caution point, the first point of interest, and the second point of interest based on the counts C1, C2, M1, and M2 as the results of the processes in steps S40101 to S40124. For example, if processing results C1=4, C2=4, M1=3, and M2=2 are obtained, the video ratio is decided to 4:4:3:2. The reason why the initial value is set to 1 in step S40101 is that if a count remains the initial value and is not incremented when adjusting the video ratio in accordance with the count, a situation in which any of the first caution point, the second caution point, the first point of interest, and the second point of interest is not included in the video at all may occur, and such a situation should be avoided. The initial value is not limited to 1, and may be another value.

In step S40126, the CPU 101 generates, as a moving plan, a video concerning each point in accordance with the video ratio adjusted in step S40125 and the total video time. For example, consider a case in which a moving plan in which the total video time is set to 1 min, and the video ratio of the first caution point, the second caution point, the first point of interest, and the second point of interest is 4:4:3:2. In this case, a video in which the first caution point of about 18.46 sec, the second caution point of about 18.46 sec, the first point of interest of about 13.84 sec, and the second point of interest of about 9.23 sec is generated.

Here, in step S3008 of FIG. 4, a priority is set for each of the plurality of extracted first caution points. If the display time of a video concerning one point is determined to a predetermined time for example, 3 sec), the video time of each first caution point is calculated as 3.0766 sec (=18.46/6) in descending order of priority such that a total of six points are included. Note that in a case of seven points, the time is 2.637 sec per point. In a case of five points, the time is 3.692 sec per point. Distributing the time to six points is selected such that the time becomes closest to the predetermined time (3 sec).

Similarly, in step S3017 of FIG. 5, a priority is set for each of the plurality of extracted second caution points. In step S3026 of FIG. 6, a priority is set for each of the plurality of extracted first points of interest. In step S3034 of FIG. 7, a priority is set for each of the plurality of extracted second points of interest. As in this step, the video time of each of the plurality of second caution points is calculated in descending order of priority, the video time of each of the plurality of first points of interest is calculated in descending order of priority, and the video time of each of the plurality of second points of interest is calculated in descending order of priority.

In accordance with the video time of each point calculated in the above-described way, the videos concerning the points are generated as a moving plan Here, the display order of the points in the video is the order a appearance from the departure place to the destination on the mute. However, the order need not always be the order of appearance. For example, the caution points may be displayed first together, and the points of interest may be displayed later together, or vice versa. The series of processes shown in FIGS. 9A and 9B thus ends.

As described above, according to an embodiment of the present invention, the user can easily grasp the caution points or points of interest on the route from the departure place to the destination in advance. Hence, since the information of important points can preliminarily be checked before traveling, the convenience of the user can be improved. In addition, since provided information is different for each user, it is possible to provide information more appropriate for each user.

### Other Embodiments

Several preferred embodiments have been described above. However, the present invention is not limited to these examples and may partially be modified without departing from the scope of the invention. For example, another element may be combined with the contents of each embodiment in accordance with the object, the application purpose, and the like, and part of the contents of a certain embodiment may be combined with the contents of another embodiment. In addition, individual terms described in this specification are merely used for the purpose of explaining the present invention, and the present invention is not limited to the strict meanings of the terms and can also incorporate their equivalents.

Furthermore, a program that implements at least one fiction described in the embodiment is supplied to a system or an apparatus via a network or a storage medium, and at least one processor in the :computer of the system or the apparatus can read out and execute the program. The present invention can be implemented by this form as well.

<Summary of Embodiment

A generation apparatus according to the first aspect is

a generation apparatus (for example, 10) for generating a moving plan including information of a feature point on a route, comprising:

an extraction unit (for example, 101) configured to extract the information of the feature point on the route; and

a generation unit (for example, 101) configured to generate the moving plan based on the information of the feature point and profile information of a user.

It is therefore possible to provide, for each user, information concerning a feature point important for the user on the route.

In the generation apparatus according to the second aspect,

the information of the feature point is information of a caution point and a point of interest on the route, and

the generation unit adjusts a ratio of the caution point and the point of interest based on the profile information and generates the moving plan.

It is therefore possible to provide, for each user, caution points and points of interest important for the user at an appropriate ratio.

The generation apparatus according to the third aspect

further comprises an acquisition unit (for example, 101, 103) configured to acquire traveling information of a plurality of vehicles (for example, 20), and

the extraction unit extracts the information of the caution point based on the traveling information.

It is therefore possible to extinct information of a point requiring attention, which is collected from various vehicles.

In the generation apparatus according to the fourth aspect, the caution point includes a first caution point where the user readily takes a wrong, road.

It is therefore possible to extract information of a point where the user readily takes a wrong road, which is collected from various vehicles.

In the generation apparatus according to the fifth aspect,

the traveling information includes occurrence information of a reroute for a guided route, and

the extraction unit extracts information of the first caution point based on the occurrence information of the reroute.

It is therefore possible to extract, as the point where the user readily takes a wrong road, a point where reroute of a navigation route occurred in the past because, for example, the vehicle traveled straight although it should turn left.

In the generation apparatus according to the sixth aspect,

the traveling information includes occurrence information of a U-turn, and

the extraction unit extracts information of the first caution point based on the occurrence information of the U-turn.

It is therefore possible to extract, as the point where the user readily takes a wrong road, a point where the vehicle passed the point and a U-turn occurred.

In the generation apparatus according to the seventh aspect,

the traveling information includes operation information concerning a scale change operation of a map displayed on a route guide screen, and

the extraction unit extracts information of the first caution point based on the operation information.

It is therefore possible to extract, as the point where the user readily takes a wrong road, a point where an operation of enlarging or reducing a map was performed in the past because the road was difficult to find or the driver got lost.

In the generation apparatus according to the eighth awed,

the traveling information includes speed information of the plurality of vehicles (for example, 20), and

the extraction unit extracts information of the first caution point based on the speed information.

It is therefore possible to extract, for example, a point where the speed of the vehicle readily decrease as the point where the user readily takes a wrong mad.

The generation apparatus according to the ninth aspect

further comprises a determination unit (for example, 101) configured to determine whether some vehicles of the plurality of vehicles travel slow or stop for not less than a predetermined time, and

the extraction unit extracts, as the information of the first caution point, information of a point for which the determination unit determines that the some vehicles travel slow or stop for not less than the predetermined time.

It is therefore possible to extract, as the point where the user readily takes a wrong road, a point where the vehicle readily travels slow or stops for the predetermined time or more.

In the generation apparatus according to the 10th aspect,

the traveling information further includes image capturing information of an outside camera (for example, 205) installed on a vehicle (for example, 20),

the determination unit determines based on the image capturing information whether another vehicle exists in the periphery of the vehicle on which the outside camera is installed and further determines whether a traffic signal indicates a stop signal, and

if the determination unit determines that the other vehicle does not exist in the periphery of the vehicle on which the outside camera is installed, and the traffic signal does not indicate the stop signal, the extraction unit extracts, a the information of the first caution point, the information of the point for which the determination unit determines that the some vehicles travel slow or stop for not less than the predetermined time.

Hence, since a point where a slow traveling or stop occurred in the past for the predetermined time or more can be extracted even if a particular traveling disturbance was absent can be extracted, a more appropriate caution point can be extracted.

In the generation apparatus according to the 11th aspect,

the traveling information includes image capturing information of an inside camera (for example, 204) installed in a vehicle (for example, 20),

the apparatus further comprises a determination unit (for example, 101) configured to determine behavior information of a driver based on the image capturing information, and

the extraction unit extracts information of the first caution point based on the behavior information of the driver.

Hence, the point where the user readily takes a wrong road can be extracted from the driver's behavior of for example, looking around, gazing the screen of the navigation device for a long time, or operating a smartphone for a long time.

In the generation apparatus according to the 12th aspect,

the traveling information includes sound collection information of a sound collecting microphone (for example, 206) installed in a vehicle (for example, 20), and

the extraction unit extracts information of the first cautioun point based on the sound collection information.

It is therefore possible to extract, as the point where the user readily takes a wrong road, a point where a filler (a word such as “eh”, “well”, or “nh” inserted in a conversation) or a keyword such as “made a mistake” was detected in the past.

In the generation apparatus according to the 13th aspect,
the traveling information includes heart rate information measured by a heart rate measuring device attached to a driver of a vehicle (for example, 20), and
the extraction unit extracts information of the first caution point based on the heart rate information.

It is therefore possible to extract a point where the heart rate abruptly arose as the point where the user readily takes a wrong road.

In the generation apparatus according to the 14th aspect,

the caution point includes a second caution point where an abrupt stop readily occurs.

It is therefore possible to extract information of a point where an abrupt stop readily occurs, which is collected from various vehicles.

The generation apparatus according to the 15th aspect

further comprises an acquisition unit (for example, 101, 102, 103) configured to acquire traveling information of a plurality of vehicles, and

the extraction unit extracts information of the second caution point based on the traveling information.

It is therefore possible to extract information of a point requiring attention, which is collected from various vehicles.

In the generation apparatus according to the 16th aspect,

the traveling information includes acceleration format of a vehicle, and

the extraction unit extracts information of the second caution point based on the acceleration information.

It is therefore possible to extract, as the point where an abrupt stop readily occurs, a point where, for example, the absolute value of the acceleration at the time of deceleration was large (equal to or larger than a predetermined value) in the past.

In the generation apparatus according to the 17th aspect,

the traveling information includes stepping information of a brake pedal, and

the extraction unit extracts information of the second caution point based on the stepping information.

It is therefore possible to extract, as the point here an abrupt stop readily occurs, a point where large stepping (a stepping amount equal to or larger than a predetermined value) occurred in the past.

In the generation apparatus according to the 18th aspect,

the traveling information includes actuation information of an anti-lock brake system (ABS), and

the extraction unit extracts information of the second caution point based on the actuation information.

It is therefore possible to extract a point where the ABS was actuated in the past as the point where an abrupt stop readily occurs.

In the generation apparatus according to the 19th aspect,

the traveling information includes actuation information of an automatic brake, and

the extraction unit extracts information of the second caution point based on the actuation information.

It is therefore possible to extract a point where the automatic brake was actuated in the past as the point where an abrupt stop readily occurs.

In the generation apparatus according to the 20th aspect,

the traveling information includes actuation information of an adaptive cruise control (ACC), and

the extraction unit extracts information of the second caution point based on the actuation information.

It is therefore possible to extract a point where the ACC was actuated, and abrupt deceleration occurred in the past as the point where an abrupt stop readily occurs.

In the generation apparatus according to the 21st aspect,

the traveling information includes actuation information of a horn, and

the extraction unit extracts information of the second caution point based on the actuation information.

It is therefore possible to extract a point where the horn was actuated in the past as the point where an abrupt stop readily occurs.

The generation apparatus according to the 22nd aspect

further comprises an acquisition unit (for example, 101, 102, 103) configured to acquire traveling information of a plurality of vehicles, and

the extraction unit extracts the information of the point of interest based on the traveling information.

It is therefore possible to extract information of a point that is a point of interest collected from various vehicles.

In the generation apparatus according to the 23rd aspect,

the point of interest includes a first point of interest in which the user is assumed to be interested.

It is therefore possible to extract information of a point of interest important for the user.

In the generation apparatus according to the 24th aspect,

the traveling information includes history information of a point where the user made a stop in the past, and

the extraction unit extracts information of the first point of interest based on the history information.

It is therefore possible to extract a point of interest according to the interest/preference of the user.

In the generation apparatus according to the 25th aspect,

the traveling information includes sound collection information of a sound collecting microphone (for example, 206) installed in a vehicle (for example, 20), and

the extraction unit extracts information of the first point of interest based on the sound collection information.

It is therefore possible to extract a point of interest according to the interest/preference of the user from, for example, a keyword obtained from utterance contents of the user during traveling or utterance contents of a passenger (for example, an acknowledgement response or the like to the words of the user).

The generation apparatus according to the 26th aspect

further comprises an acquisition unit (for example, 101, 103) configured to acquire one of payment information of electronic money by the user and search history information of the Internet by the user, and

the extraction unit extracts the information of the first point of interest based on one of the payment information and the search history information.

It is therefore possible to extract a point of interest according to the interest/preference of the user from, for example, store information where payment was done, facility information where a service was used, or a keyword recently used for a search many times, which is acquired from the Internet.

In the generation apparatus according to the 27th aspect,

the point of interest includes a second point of interest in which another user other than the user is interested.

It is therefore possible to extract a point of interest n which general users are widely interested.

The generation apparatus according to the 28th aspect

further comprises an acquisition unit (for example, 101, 103) configured to acquire search history information of the Internet by the other user, and

the extraction unit extracts the information of the second point of interest based on the search history information.

It is therefore possible to extract a point of interest in which general users are widely interested by a simple operation of accessing the Internet.

The generation apparatus according to the 29th aspect

further comprises an acquisition unit (for example, 101, 103) configured to acquire feedback information representing whether the other user actually made a stop at a point of interest provided to the other user, and

the extraction unit extracts the information of the second point of interest based on the feedback information.

It is therefore possible to extract an accurate point of interest in which other users are actually interested, in accordance with reviews of the other wide and general users.

In the generation apparatus according to the 30th aspect,

the traveling information includes history information of a point where the user made a stop in the past, and

the extraction unit extracts information of the second point of interest based on the history information.

It is therefore possible to extract, as a point of interest, a point in which other users are interested and which can be referred to by the user.

In the generation apparatus according to the 31st aspect,

the profile information includes the number of times of traveling in the past by the user for each of a plurality of links of the route, and

for a link for which the number of times of traveling is not more than a threshold, the generation unit performs adjustment such that a ratio of the caution point becomes higher than a ratio of the point of interest.

Hence, since information of the caution point can be increased for a link where the user did not travel in the past, traveling more safe for the user can be performed.

In the generation apparatus according to the 32nd aspect,

the profile information includes type information of a vehicle to be used by the user when moving on the route, and

if the user uses a two-wheeled vehicle, the generation unit performs adjustment such that a ratio of the caution point becomes higher than a ratio of the point of interest.

Hence, since the ratio of caution points can be increased for a two-wheeled vehicle that is more unstable than a four-wheeled vehicle, traveling more safe for the user can be performed.

In the generation apparatus according to the 33rd aspect,

the profile information includes information concerning a passenger of the user, and

if the passenger does not exist, the generation unit performs adjustment such that a ratio of the caution point becomes higher than a ratio of the point of interest.

If a passenger does not exist, as described above, driving assist from a passenger cannot be expected. For this reason, the ratio of caution points is increased, thereby performing traveling more safe for the user.

In the generation apparatus according to the 34th aspect,

the point of interest includes a first point of interest in which the user is assumed to be interested, and a second point of interest in which another user other than the user is interested, and

if the passenger does not exist, the, generation unit performs adjustment such that a ratio of the first point of interest becomes higher than a ratio of the second point of interest in the points of interest.

If a passenger does not exist, as described above, the ratio of points interest in which the user himself/herself is interested is made higher than the ratio of points of interest in which other users are interested. This can provide information appropriate for the user.

In the generation apparatus according to the 35th aspect,

if the passenger exists, and the passenger is a person in close relationship with the user, the generation unit performs adjustment such that a ratio of the first point of interest becomes higher than a ratio of the second point of interest in the points of interest.

If the passenger is a person (for example, family, a boyfriend/girlfriend, a friend who frequently rides together, or the like) in close relationship with the user, as described above, the ratio of points of interest in which the user himself/herself is interested is raised. This can provide information appropriate for the user.

In the generation apparatus according to the 36th aspect,

if a plurality of passengers exist, and the passengers are persons not in close relationship with the user, the generation unit per adjustment such that a ratio of the second point of interest becomes not less than a ratio of the first point of interest in the points of interest.

If the passenger is a person (for example, a friend who rarely rides together, or the like) not in dose relationship with the user as described above, the ratio of points of interest in which wide general other users are interested is raised. This can provide information in consideration of the passenger.

In the generation apparatus according to the 37th aspect,

the profile information includes information of a scheduled traveling date/time of the route set by the user, and

if the scheduled traveling date/time of the route is a holiday, or if the scheduled traveling date/time of the route is daytime, the generation unit performs adjustment such that a ratio of the point of interest becomes higher than a ratio of the caution point.

If the scheduled traveling date is a holiday or if the scheduled traveling time is daytime, as described above, the ratio of points of interest is made higher than the ratio of caution points. This can provide information more appropriate for the user.

In the generation apparatus according to the 38th aspect,

the profile information includes in of a destination of the route set by the user, and

if the destination of the route is a user's home, the generation unit performs adjustment such that a ratio of the caution point becomes higher than a ratio of the point of interest,

If the destination is the user's home, as described above, it is assumed that the driver is on his/her way home. For this reason, when the ratio of caution points is raised in consideration of fatigue or the like, it is possible to provide information more appropriate for the user,

In the generation apparatus according to the 39th aspect,
if the destination of the route is a commercial facility, the generation unit performs adjustment such that a ratio of the point of interest becomes higher than a ratio of the caution point.

If the destination is a commercial facility, the purpose is sightseeing or pleasure in many cases and it is assumed that the user is interested in various points of interest. For this reason, when the ratio of points of interest is raised, it is possible to provide information more appropriate for the user.

In the generation apparatus according to the 40th aspect, the profile information includes information of one of a scheduled traveling distance and a scheduled traveling time of the route set by the user, and if the scheduled traveling distance of the route is not less than a predetermined distance, or if the scheduled traveling time is not less than a predetermined time, the generation unit performs adjustment such that a ratio of the caution point becomes higher than a ratio of the point of interest.

Hence, if the scheduled traveling distance is long, or if the scheduled traveling time is long, the ratio of caution points is raised in consideration of fatigue or the like. This can provide information more appropriate for the user.

In the generation apparatus according to the 41st aspect,

the profile information includes driving skill information of a vehicle (for example, 20) by the user, and

the generation unit generates the moving plan by adjusting the ratio of the caution point and the point of interest based on the driving skill information.

Hence, if the driving skill of the user is high, the ratio of points of interest is raised. If the driving skill of the user is low, the ratio of caution points is raised. This can provide information more appropriate for the user.

In the generation apparatus according to the 42nd aspect,

the profile information includes weather information at a scheduled traveling date/time of the route set by the user, and

the generation unit generates the moving plan by adjusting the ratio of the caution point and the point of interest based on the weather information at the scheduled traveling date/time of the route.

Hence, if for example, the weather at the traveling date/time is a bad weather (for example, heavy rain, snow, dense fog, or the like), the ratio of caution points is raised. This can provide information more appropriate for the user.

In the generation apparatus according to the 43rd aspect,

the profile information includes information on a natural disaster in the periphery of the route set by the user, and

if the route is included in an area where the natural disaster information is issued, the generation unit performs adjustment such that a ratio of the caution point becomes higher than a ratio of the point of interest.

Hence, if, for example, there is an announcement of information on a natural disaster (for example, landslide, river flooding, volcanic eruption, road surface freeze, or the like) in the periphery of the route, the ratio of caution points is raised. This can provide information more appropriate for the user.

The generation apparatus according to the 44th aspect

further comprises an output unit (for example, 101, 103) configured to output the moving plan to the user.

Hence, the user can visually grasp the generated moving plan via the screen of the navigation device of the vehicle or a communication device (smartphone or the like).

In the generation apparatus according to the 45th aspect,

the moving plan is a video concerning the feature point on the route.

It is therefore possible to grasp information appropriate for each user as a video.

In the generation apparatus according to the 46th aspect,

the video is a video that sequentially displays each feature point from a departure place to a destination of the route.

It is therefore possible to easily grasp information of feature points from the departure place to the destination in a short time.

A control method of a generation apparatus according to the 47th aspect is

a control method of a generation apparatus (for example 10) for generating a moving plan including information of a feature point on a route, comprising:

extracting the information of the feature point on the route; and

generating the moving plan based on the information of the feature point and profile information of a user.

It is therefore possible to provide, for each user, information concerning a feature point important for the user on the route.

A non-transitory computer-readable storage medium according to the 48th aspect is

a non-transitory computer-readable storage medium storing a computer program for causing a computer to function as a generation apparatus (for example, 10) described in any one of the first to 46th aspects.

It is therefore possible to implement processing of the generation apparatus by the computer.

According to the present invention, it is possible to provide, for each user information concerning a feature point important for the risen on a route.

What is claimed is:

1. A generation apparatus for generating a moving plan including information of a feature point on a route, comprising:
an extraction unit configured to extract the information of the feature point on the route; and
a generation unit configured to generate the moving plan based on the information of the feature point and profile information of a user.

2. The apparatus according to claim 1, wherein the information of the feature point is information of a caution point and as point of interest on the route, and
the generation unit adjusts a ratio of the caution point and the point of interest based on the profile information and generates the moving plan.

3. The apparatus according to claim 2, further comprising an acquisition unit configured to acquire traveling information of a plurality of vehicles, wherein the extraction unit extracts the information of the caution point based on the traveling information.

4. The apparatus according to claim 3, wherein the caution point includes a fast caution point where the user readily takes a wrong road.

5. The apparatus according to claim 4, wherein the traveling information includes operation information concerning a scale change operation of a map displayed on a route guide screen, and
the extraction unit extracts information of the first caution point based on the operation information.

6. The apparatus according to claim 4, wherein the traveling information includes speed information of the plurality of vehicles and image capturing information of an outside camera installed on a vehicle,
the apparatus fluffier comprises a determination unit configured to determine based on the speed information whether some vehicles of plurality of vehicles travel slow or stop for not less than a predetermined time,
the determination unit further determines based on the image capturing information whether another vehicle exists in the periphery of the vehicle on which the outside camera is installed and further determines whether a traffic signal indicates a stop signal, and
if the determination unit determines that the other vehicle does not exist in the periphery of the vehicle on which the outside camera is installed, and the traffic signal does not indicate the stop signal, the extraction unit extracts, as the information of the first caution point, the information of the point for which the determination unit determines that the some vehicles travel slow or stop for not less than the predetermined time.

7. The apparatus according to claim 2, wherein the point of interest includes a second point of interest in which other users other than the user are interested,
the apparatus further comprises an acquisition unit configured to acquire traveling information of a plurality of vehicles and acquiring feedback information representing whether the other user actually made a stop at a point of interest provided to the other user,
wherein the extraction unit extracts the information of the second point of interest based on the traveling information and the feedback information.

8. The apparatus according to claim 2, wherein the profile information includes the number of times of traveling in the past by the user for each of a plurality of links of the route, and
for a link for which the number of times of traveling is not more than a threshold, the generation unit performs adjustment such that a ratio of the caution point becomes higher than a ratio of the point of interest.

9. The apparatus according to claim 2, wherein the profile information includes type information of a vehicle to be used by the user when moving on the route, and
if the user uses a two-wheeled vehicle, the generation unit performs adjustment such that a ratio of the caution point becomes higher than a ratio of the point of interest.

10. The apparatus according to claim 2, wherein the profile information includes information concerning a passenger of the user, and
if the passenger does not exist, the generation unit performs adjustment such that a ratio of the caution point becomes higher than a ratio of the point of interest.

11. The apparatus according to claim 10, wherein the point of interest includes a first point of interest in which the user is assumed to be interested, and a second paint of interest in which another user other than the user is interested, and
if the passenger does not exist, the generation unit performs adjustment such that a ratio of the first point of interest becomes higher than a ratio of the second point of interest in the points of interest.

12. The apparatus according to claim 10, wherein if the passenger exists, and the passenger is a person in close relationship with the user, the generation unit performs adjustment such that a ratio of the first point a interest becomes higher than a ratio of the second point of interest in the points of interest.

13. The apparatus according to claim 10, wherein if a plurality of passengers exist, and the passengers are persons not in close relationship with the user, the generation unit performs adjustment such that a ratio of the second point of interest becomes not less than a ratio of the first point of interest in the points of interest.

14. The apparatus according to claim 2, wherein the profile information includes information of a scheduled traveling date/time of the mute set by the user, and
if the scheduled traveling date/time a the route is a holiday, or if scheduled traveling date/time of the route is daytime, the generation unit performs adjustment such that a ratio of the point of interest becomes higher than a ratio of the caution point.

15. The apparatus according to claim 2, wherein the generation unit decides a ratio of the caution point and a ratio of the point of interest based on a purpose of movement.

16. The apparatus according to claim 2, wherein the profile information includes driving skill information of a vehicle by the user, and
the generation unit generates the moving plan by adjusting the ratio of the caution point and the point of interest based on the driving skill information.

17. The apparatus according to claim 2, wherein the profile information includes weather information at a scheduled traveling date/time of the route set by the user, and
the generation unit generates the moving plan by adjusting the ratio of the caution point and the point of interest based on the weather information at the scheduled traveling date/time of the route.

18. The apparatus according to claim 2, wherein the profile information includes information on a natural disaster in the periphery of the route set by the user, and
if the route is included in an area where the natural disaster information is issued, the generation unit performs adjustment such that a ratio of the caution point becomes higher than a ratio of the point of interest.

19. A control method of a generation apparatus for generating a moving plan including information of a feature point on a route comprising:
extracting the information of the feature point on the route; and
generating the moving plan based on the information of the feature point and profile information of a user.

20. A non-transitory computer-readable storage medium storing a computer program for causing a computer to execute a control method of a generation apparatus for generating a moving plan including information of a feature point on a route, the control method comprising:
extracting the information of the feature point on the route; and
generating the moving plan based on the information of the feature point and profile information of a user.
